(19) United States
(12) Patent Application Publication
(10) Pub. No.: US 2012/0308847 A1
(43) Pub. Date: Dec. 6, 2012

(54) METHOD FOR FABRICATING HIGH CONTRAST STACKS

(75) Inventors: Bin Lu, San Ramon, CA (US); René Johannes Marinus Van de Veerdonk, Pleasanton, CA (US)

(73) Assignee: SEAGATE TECHNOLOGY, LLC, Cupertino, CA (US)

(21) Appl. No.: 13/149,596

(22) Filed: May 31, 2011

(51) Int. Cl. B05D 5/12; B05C 11/00; G11B 5/72

(52) U.S. Cl. 428/846; 427/130; 118/600

(57) ABSTRACT

The embodiments disclose a method for fabricating high contrast stacks, including depositing materials on a substrate to form an antiferromagnetic coupling thin film layer on top of a first half of the magnetic layer of a stack, depositing a portion of a second half of the magnetic layer on top of the antiferromagnetic coupling thin film layer to couple the first and second half of the magnetic layers to the antiferromagnetic coupling thin film layer and bit-patterning a portion of the second half of the magnetic layer and the antiferromagnetic coupling thin film layer.

### BACKGROUND

Fabrication methods of bit patterned devices and discrete track devices utilize the physical removal of magnetic materials for increasing magnetic contrast, where some magnetic materials can be a thick layer. Removal of a thick magnetic layer creates surface roughness which leads to additional processes such as polishing in order to achieve a smooth top surface for flyability and small head to media spacing. Also, removal of the magnetic materials is a complicated and lengthy process, and thus, very costly.

### BRIEF DESCRIPTION OF THE DRAWINGS

FIG. 1 shows a block diagram of an overview of a method for fabricating high contrast stacks of one embodiment.

FIG. 2A shows a block diagram of an overview flow chart of a method for fabricating high contrast stacks of one embodiment.

FIG. 2B shows a block diagram of high magnetic contrast in a stack of one embodiment.

FIG. 3A shows for illustrative purposes only an example of a layered stack structure of one embodiment.

FIG. 3B shows for illustrative purposes only an example of a thin film deposited on a first half of the magnetic layer of a stack of one embodiment.

FIG. 3C shows for illustrative purposes only an example of a patterned thin film deposited on a first half of the magnetic layer of a stack of one embodiment.

FIG. 3D shows for illustrative purposes only an example of longitudinal magnetic moment orientation of a stack of one embodiment.

FIG. 3E shows for illustrative purposes only an example of perpendicular magnetic moment orientation of a stack of one embodiment.

FIG. 4A shows for illustrative purposes only an example of a single antiferromagnetic coupling thin film layer on top of a first half of the magnetic layer of one embodiment.

FIG. 4B shows for illustrative purposes only an example of a patterned single antiferromagnetic coupling of one embodiment.

FIG. 4C shows for illustrative purposes only an example of a full second half of the magnetic layer and overcoat layer on top of a patterned single antiferromagnetic coupling thin film layer of one embodiment.

FIG. 5A shows for illustrative purposes only an example of a multilayered antiferromagnetic coupling thin film layer deposited on top of a first half of the magnetic layer of one embodiment.

FIG. 5B shows for illustrative purposes only an example of a patterned multilayered antiferromagnetic coupling thin film layer of one embodiment.

FIG. 5C shows for illustrative purposes only an example of a full second half of the magnetic layer and overcoat layer deposited on top of a patterned multilayered antiferromagnetic coupling thin film layer of one embodiment.

FIG. 6A shows for illustrative purposes only an example of a multilayered antiferromagnetic coupling enhancing thin film layer and depositing a portion of the second half of the magnetic layer on top of a first half of the magnetic layer of one embodiment.

FIG. 6B shows for illustrative purposes only an example of patterning a portion of the second half of the magnetic layer and a multilayered antiferromagnetic coupling enhancing thin film layer of one embodiment.

FIG. 6C shows for illustrative purposes only an example of depositing a full second half of the magnetic layer and overcoat layer on top of a patterned portion of the second half of the magnetic layer and multilayered antiferromagnetic coupling thin film layer of one embodiment.

### DETAILED DESCRIPTION OF THE INVENTION

In a following description, reference is made to the accompanying drawings, which form a part hereof, and in which is shown by way of illustration a specific example in which the invention may be practiced. It is to be understood that other embodiments may be utilized and structural changes may be made without departing from the scope of the embodiments.

### General Overview:

It should be noted that the descriptions that follow, for example, in terms of a method for fabricating high contrast stacks is described for illustrative purposes and the underlying system can apply to any number and multiple types of patterned stack or media.

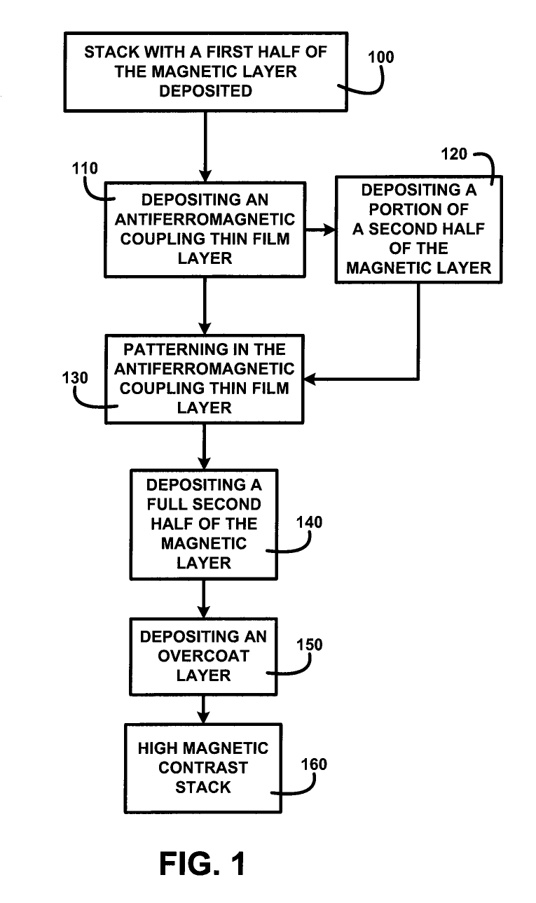

FIG. 1 shows a block diagram of an overview of a method for fabricating high contrast stacks of one embodiment. A measure of the magnetization remaining in a magnetic material after an inducing magnetic field is removed is referred to as remanent magnetization (Mr) or remanent magnetic moment density. The amplitude of the remanent magnetization (Mr) is proportional to the physical thickness (t) of the magnetic materials and is measured as the materials magnetic thickness (Mrt) of one embodiment.

A method for fabricating high contrast stacks uses a patterned antiferromagnetic coupling thin film layer such as ruthenium (Ru) between two halves of the magnetic layer to cause the magnetization in each of the halves of the magnetic layer to be coupled in opposite, or anti-parallel, directions. Ruthenium is a non-magnetic anti-ferro material. The opposite coupling of the half of the magnetic layer above and below the antiferromagnetic coupling thin film layer takes place in the trenches that are unaffected by the patterning process of one embodiment.

The antiferromagnetic opposite coupling in the trenches causes the Mrt of the first half of the magnetic layer to be cancelled by the Mrt of the second half of the magnetic layer. The cancellation of Mrt between the two halves of the magnetic layers does not have to occur in the island regions that have been patterned and have a ferromagnetic coupling. The high magnetic contrast created between the cancelled Mrt in the trenches and the non-cancelled Mrt in the island regions allows the density of the stack to be increased while maintaining stable magnetic readability using small head to media spacing of one embodiment.

In one embodiment, the method for fabricating high contrast stacks can be configured using a single antiferromagnetic coupling thin film layer between two halves of the magnetic layers as an ideal way of cancelling Mr. In another embodiment, the method for fabricating high contrast stacks may include a multilayered antiferromagnetic coupling enhancing thin film layer to enhance the antiferromagnetic coupling between the first and second magnetic layers. In one embodiment, the method for fabricating high contrast stacks may include deposition of a portion of a second half of the magnetic layer on the antiferromagnetic coupling so that the first and second halves of the magnetic layer are fully antiferromagnetic coupled and the interface region in the trench area is protected during the fabrication process. In one embodiment, the method for fabricating high contrast stacks may be used to fabricate stacks with longitudinal or perpendicular oriented magnetic moments.

In the descriptions that follow in terms of first or second half of the magnetic layer and magnetic materials refer to magnetic materials used in stacks or media and include magnetic materials configured with longitudinal, perpendicular or other magnetic moment orientations. Stacks such as bit-patterned media and discrete track media can be created as perpendicular magnetic moment oriented recording media. Both of them utilize large magnetic contrast between magnetic islands or tracks and trenches so that higher track density with clean track edges can be defined. In one embodiment, antiferromagnetism is used to cancel magnetic contrast of magnetic materials in areas of a stack or media, such as bit-patterned media or discrete track media.

FIG. 1 shows a stack with a first half of the magnetic layer deposited 100. A method for fabricating high contrast stacks begins with a process step of depositing an antiferromagnetic coupling thin film layer 110 materials on top of the first half of the magnetic layer to cancel remnant magnetization. In one embodiment after depositing an antiferromagnetic coupling thin film layer 110 the next step is depositing a portion of the second half of the magnetic layer 120 prior to patterning. The portion of the second half of the magnetic layer 120 is deposited to fully couple the first and second half of the magnetic layers to the antiferromagnetic coupling thin film layer.

In one embodiment, patterning in the antiferromagnetic coupling thin film layer 130 and the portion of the second half of the magnetic layer, if applied, is performed using processes such as used for bit-patterned media or discrete track recording patterning. In the descriptions that follow, the terms island, track, islands or tracks refer to the regions of a stack or media where a portion of the materials were removed in a patterning process. The term trench or trenches refer to the regions where no portions of materials were removed during a patterning process in the following descriptions. Patterning in the antiferromagnetic coupling thin film layer 130 creates clean low height contrast islands on the bit-patterned media or tracks of discrete track media. The patterned antiferromagnetic coupling thin film layer and portion of the second half of the magnetic layer, if applied, present clean low height contrast between the islands or tracks and the trenches that eliminates additional processes such as burnishing or polishing after patterning.

The next step after patterning may include depositing a full second half of the magnetic layer 140 on top of the antiferromagnetic coupling thin film layer and portion of the second half of the magnetic layer, if applied. Depositing a full second half of the magnetic layer 140 is configured to fill magnetic materials into the islands or tracks and apply materials on top of the trench regions until the net magnetic contrast of the trench region is fully compensated. These deposited magnetic materials form the full second half of the magnetic layer. The application of the full second half of the magnetic layer materials filling the islands or tracks will physically blur or reduce the low height contrast leaving the surface smooth. The smoothness to the surface of the full second half of the magnetic layer materials eliminates burnishing or polishing in preparation for the next step.

The next step is depositing an overcoat layer 150 on top of the full second half of the magnetic layer to achieve a smooth top surface for flyability and small head to media spacing. In one embodiment, the method for fabricating high contrast stacks may be used in a fabrication process to create high magnetic contrast stack 160 products while eliminating processes, thereby reducing cost, increasing production efficiency and delivering high quality stacks or magnetic recording media.

### DETAILED DESCRIPTION

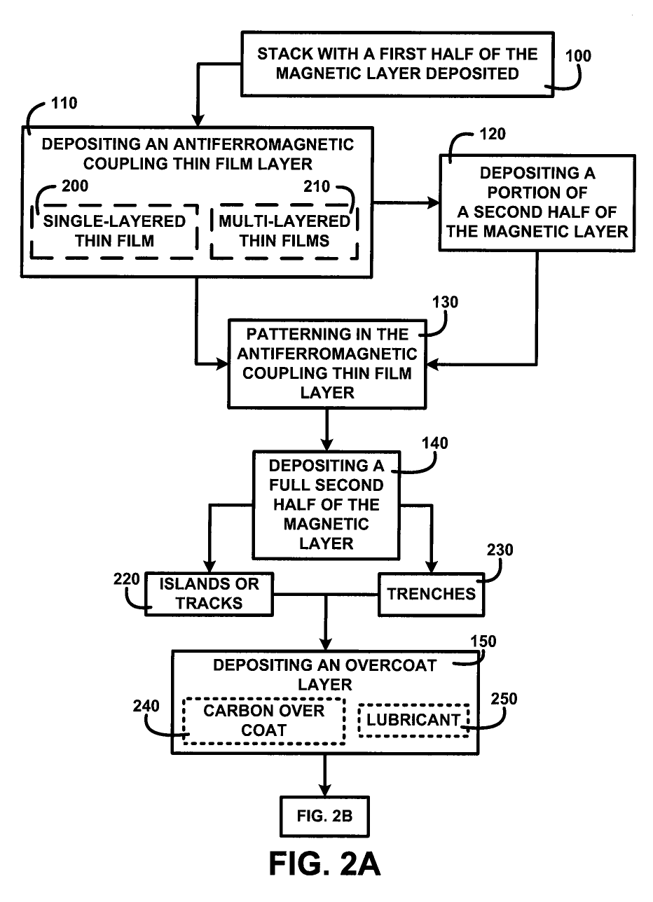

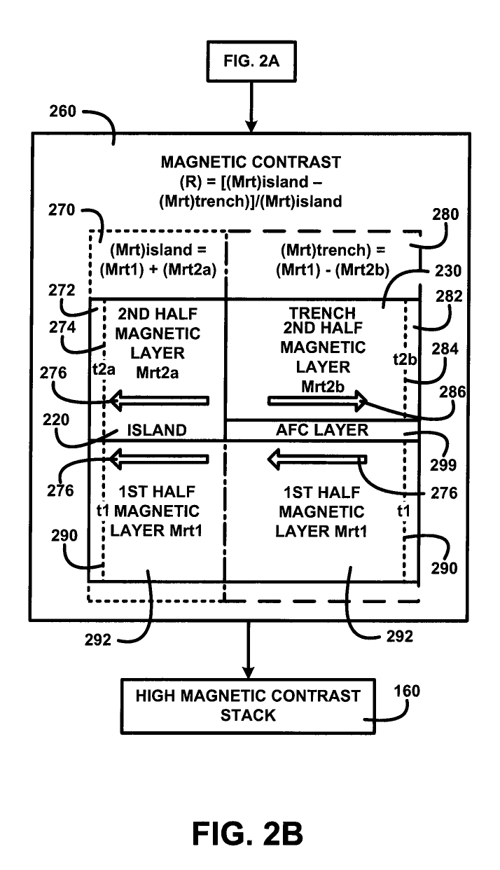

FIG. 2 shows a block diagram of an overview flow chart of a method for fabricating high contrast stacks of one embodiment. The density of a stack in part is determined by the proximity of the trenches or bits developed on the stack during fabrication. The proximity of the trenches or bits may be influenced by the magnetic contrast which affects the quality of the read and write functions of the stack. The method for fabricating high contrast stacks provides a layered structure for a stack that permits close proximity of the trenches or bits by producing high contrast through the use of an antiferromagnetic coupling. The high contrast may increase the density capability of a stack and increases the quality of the read and write functions without sacrificing density. A fabrication process using the method for fabricating high contrast stacks will deposit layers on a substrate to a point where as shown in FIG. 2 the stack with a first half of the magnetic layer deposited 100 previously is ready for the next fabrication process.

The next step is the creation of the antiferromagnetic coupling. The fabrication process using the method for fabricating high contrast stacks continues by depositing an antiferromagnetic coupling thin film layer 110 to cancel remnant magnetization. The antiferromagnetic coupling thin film layer may include depositing a single-layered thin film 200 or depositing multi-layered thin films 210 based on the desired results of one embodiment.

In one embodiment, the method for fabricating high contrast stacks is configured for example to include sputtering a single-layered thin film 200 of an anti-ferro material such as ruthenium on top of the first half of the magnetic layer. The single-layered thin film 200 used in depositing an antiferromagnetic coupling thin film layer 110 achieves an antiferromagnetic coupling between the two halves of the magnetic layers.

In another embodiment, the method for fabricating high contrast stacks is configured for example to include sputtering multi-layered thin films 210 of an antiferromagnetic material such as ruthenium and for example a thin film of pure cobalt or cobalt alloy on one or both of the top and bottom surfaces of the ruthenium thin film layer. The multi-layered thin films 210 enhance the antiferromagnetic coupling between the two halves of the magnetic layers.

In one embodiment the method for fabricating high contrast stacks may include a process step of depositing a portion of the second half of the magnetic layer 120. The portion of the second half of the magnetic layer is deposited to fully couple the first and second half of the magnetic layers with the antiferromagnetic coupling thin film layer. Depositing a portion of the second half of the magnetic layer 120 is configured to be applied or not be applied on top of the multi-layered thin films 210 of the antiferromagnetic coupling enhancing thin film layer. Depositing a portion of the second half of the magnetic layer 120 also protects the interface region in the trench area during the fabrication process for example patterning or etching processes of one embodiment.

Patterning processes in the antiferromagnetic coupling layer includes patterning the single-layered thin film 200 or the multi-layered thin films 210 and the portion of the second half of the magnetic layer, if applied. The patterning on the antiferromagnetic coupling may include the use for example patterning processes used for regular bit-patterned media, discrete track recording or other patterning process. The patterning on the antiferromagnetic coupling layer removes a portion of the antiferromagnetic coupling thin film layer and portion of the second half of the magnetic layer materials at island or track regions between trench regions. Patterning the antiferromagnetic coupling thin film layer and portion of the second half of the magnetic layer materials creates a low height contrast between the islands or tracks 220 and the trenches 230 due to the thin thicknesses deposited of one embodiment.

The patterning using for example a lithographic process performed on the thin films where the islands 220 in a bit-patterned media are the hole region where the antiferromagnetic coupling thin film layer materials have been removed. The remaining antiferromagnetic coupling thin film layers or trenches 230 may not have to have been exposed to patterning such as etching and wet chemical process are well preserved. The well preserved trenches 230 achieve a strong antiferromagnetic coupling strength. The islands or tracks are filled by depositing a full second half of magnetic materials 140 of one embodiment.

Depositing a full second half of magnetic materials 140 is performed after patterning on the antiferromagnetic coupling layer. Depositing magnetic materials into the islands or tracks 220 and on top of the trenches 230 until the net magnetic contrast of the trench region is fully compensated forms the full second half of the magnetic layer. The depositing a full second half of magnetic materials 140 is controlled for thicknesses for example to physically blur or reduce the low height contrast between the islands or tracks 220 and trenches 230 regions when completed. This forms a smoothness of the surface eliminating a process to mechanically polish the surface or any alternative means to achieve smoothness of one embodiment.

The elimination of a polish fabrication step allows the method for fabricating high contrast stacks to proceed with depositing an overcoat layer 150 directly on the surface of the full second half of the magnetic layer materials. The materials used for depositing an overcoat layer 150 may include materials such as carbon over coat 240, lubricant 250 or other materials. The depositing of an overcoat layer 150 creates a final smooth surface for flyability and small head to stack spacing of one embodiment. Increasing flyability and small head to stack spacing also contributes to the extendibility of high density.

### High Magnetic Contrast:

FIG. 2B shows a block diagram of high magnetic contrast in a stack of one embodiment. Stacks such as bit-patterned media or discrete track media utilize a sharp magnetic contrast 260. Uses such as magnetic recording media define this sharp contrast as a magnetic contrast 260 seen by the reader. The magnetic contrast 260 is defined as a ratio (R). There are two major factors making up the magnetic contrast 260, film thickness (t) and remnant magnetization (Mr). Remnant magnetization is an extrinsic property of a magnetic material. The measure of the magnetic contrast is made between the two halves of magnetic materials in the islands or tracks 220 and trenches 230.

In the islands or tracks 220 regions magnetic contrast (Mrt)island 270 is the first half of the magnetic layer Mrt1 292 added to the second half of the magnetic layer Mrt2a 272 due to ferromagnetic coupling of the two layers. The magnetic moment vector 274 of the first half of the magnetic layer has the same direction as the magnetic moment vector 274 of the second half of the magnetic layer due to the ferromagnetic coupling.

Island first half of the magnetic layer Mrt1 292 is derived from the remnant magnetization (Mr) of the magnetic material and the film thickness of the first half of the magnetic layer (t1) 290. Island second half of the magnetic layer Mrt2a 272 is derived from the remnant magnetization (Mr) of the magnetic material and the film thickness of the second half of the magnetic layer (t2a) 274.

In the trenches 230, magnetic contrast (Mrt)trench 280 is the first half of the magnetic layer Mrt1 292 cancelled by the second half of the magnetic layer Mrt2b 282 due to the antiferromagnetic coupling created by the AFC layer 299 or antiferromagnetic coupling layer. The magnetic moment vector 286 of the second half of the magnetic layer is in the opposite direction of the magnetic moment vector 274 of the first half of the magnetic layer due to the antiferromagnetic coupling.

Trench first half of the magnetic layer Mrt1 292 is derived from the remnant magnetization (Mr) of the magnetic material and the film thickness of the first half of the magnetic layer (t1) 290. Trench second half of the magnetic layer Mrt2b 282 is derived from the remnant magnetization (Mr) of the magnetic material and the film thickness of the second half of the magnetic layer (t2b) 284.

The magnetic contrast (R)=[(Mrt)island−(Mrt)trench)]/(Mrt)island 260 which results in a value of 1 since the (Mrt)trench 280 has been cancelled by the opposing magnetic moments of the first and second half of the magnetic layer due to the antiferromagnetic coupling. The method for fabricating high contrast stacks measured magnetic contrast ratio is 1, which is the highest that can be achieved of one embodiment.

Mrt of the first half of the magnetic layer and Mrt of the second half of the magnetic layer in the trench and track regions may not be exactly the same. This is because the patterning process may remove a portion of the first half of the magnetic layer only in the islands or tracks 220 regions of one embodiment. In another embodiment a very small amount of the first half of the magnetic layer may be removed when patterning the AFC layer. Thus, Mrt of the first half of the magnetic layer may be slightly smaller in the track region than in the trench region.

In one embodiment the thicknesses of the depositions of the first half of the magnetic layer and second half of the magnetic layer in the trench regions are adjustable. The thicknesses of the depositions are adjusted wherein the sum Mrt1(i) of the first half of the magnetic layer in one embodiment may be about equal to the sum Mrt2(i) of the second half of the magnetic layer that remain in the trench regions at the end of the processes to fully compensate the Mrt of the trenches. The values of Mrt1 and Mrt2 that combine as Mrt1+Mrt2 in the island or track regions are also compensated by the adjustments of the thicknesses of the depositions in one embodiment.

The method for fabricating high contrast stacks eliminates processes reducing fabrication cost. Eliminating processes reduces fabrication time leading to increased productivity. The method for fabricating high contrast stacks may be used in a fabrication process to increase high magnetic contrast stack 160 production with less processing time, reduced process cost and fabrication of higher performance high density quality products of one embodiment.

### Layered Stack Structure:

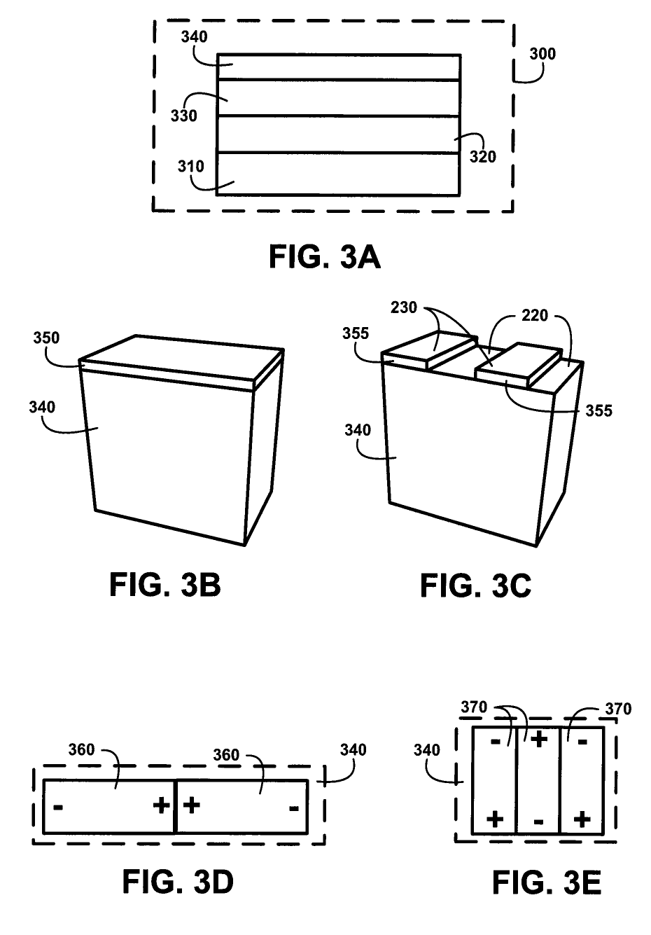

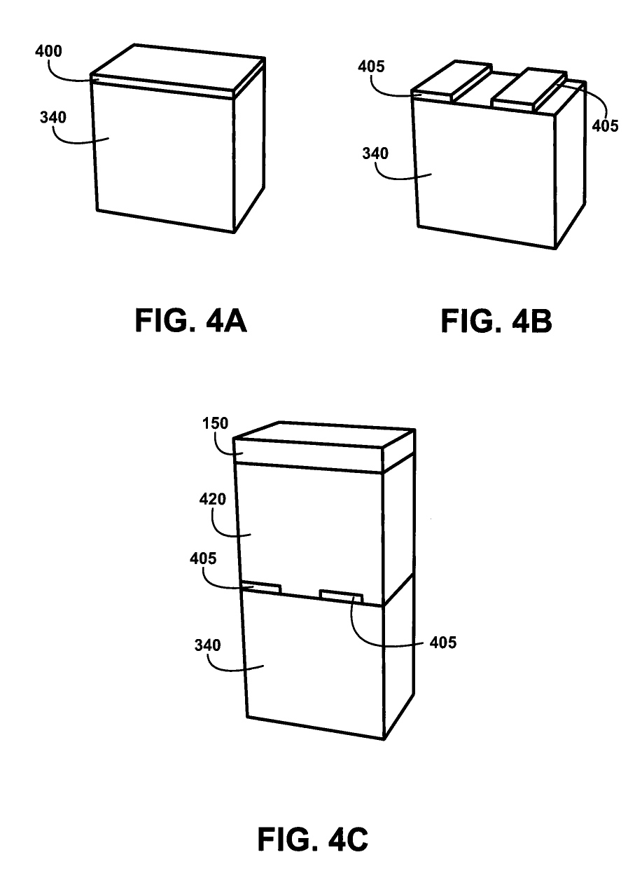

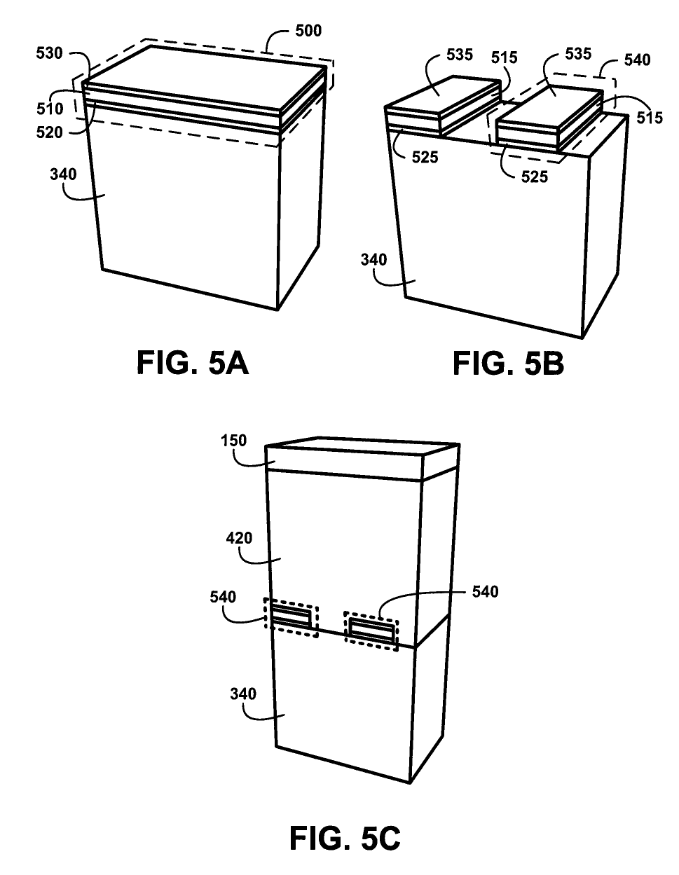

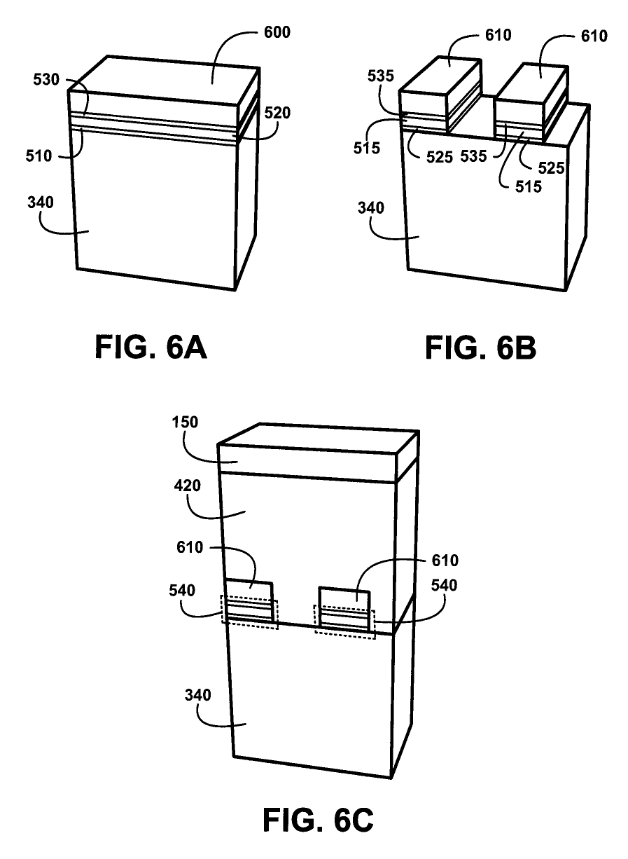

FIG. 3A shows for illustrative purposes only an example of a layered stack structure of one embodiment. FIG. 3A shows a layered stack structure 300 at a stage of fabrication that includes a substrate 310, soft magnetic layer 320, seedlayer and interlayer 330 and a first half of the magnetic layer 340. The stack with a first half magnetic layer deposited 100 of FIG. 1 is ready for the next step that may include depositing an antiferromagnetic coupling thin film layer 110 of FIG. 1. In the following figures FIG. 3B, FIG. 3C, FIG. 4A, FIG. 4B, FIG. 4C, FIG. 5A, FIG. 5B, FIG. 5C, FIG. 6A, FIG. 6B and FIG. 6C only the first half of the magnetic layer 340 of the layered stack structure 300 is shown for clarity. The remainder of the layered stack structure 300, the substrate 310, soft magnetic layer 320, seedlayer and interlayer 330 not shown are to be considered there by this reference.

### Thin Film Deposited:

FIG. 3B shows for illustrative purposes only an example of a thin film deposited on a first half of the magnetic layer of a stack of one embodiment. FIG. 3B shows materials deposited upon the first half of the magnetic layer 340 in a thin film 350. The thin film 350 deposited may be configured as a single-layered thin film 200 of FIG. 2. The method for fabricating high contrast stacks may include sputtering a thin film layer 350 of ruthenium (Ru) in a thickness of for example 0.3-2 nm. The thin film 350 may include deposition of materials that will form an antiferromagnetic coupling. Two or more layers of a thin film 350 may be deposited that may include layers of differing materials or compounds. The deposits of two or more layers may be configured as multi-layered thin films 210 that will form an antiferromagnetic coupling

### Stack Topography:

FIG. 3C shows for illustrative purposes only an example of a patterned thin film deposited on a first half of the magnetic layer of a stack of one embodiment. FIG. 3C shows topographical features of a patterned thin film 355 on the first half of the magnetic layer 340 of a stack. In the following descriptions some the terms holes, recesses, island, track or islands or tracks 220 will mean those topographical features where patterning has removed materials of thin films that have been previously deposited as shown in FIG. 3C. In the following descriptions the terms trench or trenches 230 will mean those topographical features where patterning may not have to have been removed materials of thin films that have been previously deposited as shown in FIG. 3C.

The method for fabricating high contrast stacks may include patterning on the antiferromagnetic coupling thin film layer 130 and thin portion of a second half magnetic layer that may create topographical features on a stack. The method for fabricating high contrast stacks performs patterning for example only on the thin film deposits of an antiferromagnetic coupling and thin portion of a second half magnetic layer. The low height contrast for example 0.3-2 nm between the islands or tracks 220 and trenches 230 eliminates a polishing step to create for example a roughness AFM Ra<0.5 nm to the surface of the patterned topography of one embodiment.

### Longitudinal Magnetic Moment Orientation:

FIG. 3D shows for illustrative purposes only an example of longitudinal magnetic moment orientation of a stack of one embodiment. FIG. 3D shows the first half of the magnetic layer 340 of a magnetic stack or media with longitudinal magnetic moment orientation 360 where the magnetic poles are matched parallel to the substrate. The method for fabricating high contrast stacks may include depositing an antiferromagnetic coupling thin film layer 110 of FIG. 1 on a stack that is configured with for example longitudinal magnetic moment orientation. A stack for example a bit-patterned media may be fabricated to include a longitudinal magnetic moment orientation of one embodiment.

### Perpendicular Magnetic Moment Orientation:

FIG. 3E shows for illustrative purposes only an example of perpendicular magnetic moment orientation of a stack of one embodiment. FIG. 3E shows the first half of the magnetic layer 340 of a magnetic stack or media with a perpendicular magnetic moment orientation 370 where the magnetic poles are opposite vertically. The method for fabricating high contrast stacks may include depositing an antiferromagnetic coupling thin film layer 110 of FIG. 1 on a stack that is configured with for example perpendicular magnetic moment orientation. A stack for example a discrete track media may be fabricated to include a perpendicular magnetic moment orientation of one embodiment.

### Single Antiferromagnetic Coupling Thin Film Layer:

FIG. 4A, FIG. 4B and FIG. 4C show one embodiment configured using the single-layered thin film 200 of FIG. 2 antiferromagnetic coupling thin film layer to achieve antiferromagnetic coupling between the two halves of the magnetic layers. FIG. 4A shows for illustrative purposes only an example of a single antiferromagnetic coupling thin film layer on top of a first half of the magnetic layer of one embodiment. FIG. 4A shows the first half of the magnetic layer 340 deposited. The next step of the method for fabricating high contrast stacks may include depositing a single antiferromagnetic coupling thin film layer 400 configured using the single-layered thin film 200 of FIG. 2 of one embodiment.

The single antiferromagnetic coupling thin film layer 400 is configured to be formed by sputtering a thin film of a material such as ruthenium on top of the first half of the magnetic layer 340 to cancel remnant magnetization. The single antiferromagnetic coupling thin film layer 400 is configured to create high magnetic contrast between islands or tracks 220 of FIG. 2 and trenches 230 of FIG. 2 created in the patterning process to increase extendibility with high island or track density with clean island or track edges defined of one embodiment.

FIG. 4B shows for illustrative purposes only an example of a patterned single antiferromagnetic coupling of one embodiment. FIG. 4B shows the results of the patterning in the single layer antiferromagnetic coupling thin film layer 400 of FIG. 4A. Patterned single layer antiferromagnetic coupling thin film layer 405 on the first half of the magnetic layer 340 form the trenches 230 of FIG. 2. The single layer antiferromagnetic coupling thin film layer 400 of FIG. 4A may be patterned using a patterning process such as those used in bit-patterned or discrete track stacks. The patterned single layer antiferromagnetic coupling thin film layer 405 creates clean islands or tracks 220 of FIG. 2.

The patterning has removed portions of the thin film at islands or tracks 220 of FIG. 2. The trenches 230 of FIG. 2 of remaining thin film materials may not need to be removed in the patterning process and are well preserved. The well preserved trenches 230 of FIG. 2 achieve a strong antiferromagnetic coupling strength. The thin film thickness of the patterned single antiferromagnetic coupling thin film layer 405 creates a low height contrast between the islands or tracks 220 of FIG. 2 and trenches 230 of FIG. 2 after patterning. The low height contrast eliminates a polishing process prior to the next step as shown in FIG. 4C of one embodiment.

FIG. 4C shows for illustrative purposes only an example of a full second half of the magnetic layer and overcoat layer on top of a patterned single antiferromagnetic coupling thin film layer of one embodiment. FIG. 4C shows a full second half of the magnetic layer 420 deposited upon the patterned single antiferromagnetic coupling thin film layer 405. The full second half of the magnetic layer 420 fills the islands or tracks 220 of FIG. 2. The full second half of the magnetic layer 420 filling the islands or tracks 220 of FIG. 2 is in contact with the first half of the magnetic layer 340. The thickness of the full second half of the magnetic layer 420 may be adjusted until the net magnetic contrast of the trench region is fully compensated of one embodiment.

The deposition of the full second half of magnetic layer 420 materials filling the islands or tracks 220 of FIG. 2 will physically blur or reduce the low height contrast leaving smoothness to the surface. The smoothness to the surface of the full second half of magnetic layer 420 eliminates a burnishing or polishing process in the preparation for the next step. The patterned single antiferromagnetic coupling thin film layer 405 between the first half of the magnetic layer 340 and the full second half of the magnetic layer 420 achieves antiferromagnetic coupling between the two halves of the magnetic layers and creates high magnetic contrast. The smoothness on the surface of the full second half of the magnetic layer 420 deposition allows an overcoat layer 150 to be deposited directly on top of the full second half of the magnetic layer 420. The overcoat layer 150 is configured to include application of materials such as the carbon over coat 240 of FIG. 2 and the lubricant 250 of FIG. 2. The deposition of the overcoat layer 150 produces a smooth surface finish to the high magnetic contrast stack 160 of FIG. 1 of one embodiment.

### Multilayered Antiferromagnetic Coupling Enhancing Thin Film Layer:

FIG. 5A, FIG. 5B and FIG. 5C show one embodiment configured using the multi-layered thin film 210 of FIG. 2 antiferromagnetic coupling enhancing thin film layer to achieve antiferromagnetic coupling between the two halves of the magnetic layers. FIG. 5A shows for illustrative purposes only an example of a multilayered antiferromagnetic coupling thin film layer deposited on top of a first half of the magnetic layer of one embodiment. FIG. 5A shows the first half of the magnetic layer 340 deposited on a stack. The next step in the fabrication process using the method for fabricating high contrast stacks continues by depositing a multilayered antiferromagnetic coupling enhancing thin film layer 500 on top of the first half of the magnetic layer 340 to cancel remnant magnetization of one embodiment.

The multilayered antiferromagnetic coupling enhancing thin film layer 500 is may be formed by depositing a base antiferromagnetic coupling enhancing thin film layer 520 using for example a magnetic material such as pure cobalt or a cobalt alloy on top of the first half of the magnetic layer 340. On top of the base antiferromagnetic coupling enhancing thin film layer 520 is deposited a middle antiferromagnetic coupling thin film layer 510 for example using an antiferromagnetic material such as ruthenium. Completing the formation of the illustrated multilayered antiferromagnetic coupling enhancing thin film layer 500 is the depositing of a top antiferromagnetic coupling enhancing thin film layer 530 for example using pure cobalt or a cobalt alloy. The use of a material such as pure cobalt or a cobalt alloy for the base antiferromagnetic coupling enhancing thin film layer 520 and the top antiferromagnetic coupling enhancing thin film layer 530 enhances the antiferromagnetic coupling between the first and second magnetic layers.

In another embodiment the multilayered antiferromagnetic coupling enhancing thin film layer 500 may be formed by two thin film layers that may include the base antiferromagnetic coupling enhancing thin film layer 520 and middle antiferromagnetic coupling thin film layer 510. In another embodiment the middle antiferromagnetic coupling thin film layer 510 may be deposited on the first half of the magnetic layer 340 and include the top antiferromagnetic coupling enhancing thin film layer 530 wherein the two thin film layers in this configuration form the multilayered antiferromagnetic coupling enhancing thin film layer 500.

FIG. 5B shows for illustrative purposes only an example of a patterned multilayered antiferromagnetic coupling thin film layer of one embodiment. A patterning process such as those used in bit-patterned or discrete track stacks may be used to pattern in the multilayered antiferromagnetic coupling enhancing thin film layer 500 of FIG. 5A. A patterned multilayered antiferromagnetic coupling enhancing thin film layer 540 is configured to create high magnetic contrast between islands or tracks 220 of FIG. 2 and trenches 230 of FIG. 2. The high magnetic contrast may increase extendibility with high density with clean island or track edges defined of one embodiment.

FIG. 5B shows in one embodiment the patterned multilayered antiferromagnetic coupling enhancing thin film layer 540 formed using a patterned base antiferromagnetic coupling enhancing thin film layer 525, a patterned middle antiferromagnetic coupling thin film layer 515 and a patterned top antiferromagnetic coupling enhancing thin film layer 535. The patterned multilayered antiferromagnetic coupling enhancing thin film layer 540 is configured to create the trenches 230 of FIG. 2. After patterning, the holes where the materials of the thin film layers have been removed form the clean islands or tracks 220 of FIG. 2 on the first half of the magnetic layer 340. A strong antiferromagnetic coupling strength is achieved in the well preserved trenches 230 of FIG. 2 formed by the patterned multilayered antiferromagnetic coupling enhancing thin film layer 540 of one embodiment.

A low height contrast between islands or tracks 220 of FIG. 2 and trenches 230 of FIG. 2 is created using the thin film layers of the patterned multilayered antiferromagnetic coupling enhancing thin film layer 540. The low height contrast forestalls a polishing process prior to the next step as shown in FIG. 5C of one embodiment.

FIG. 5C shows for illustrative purposes only an example of a full second half of the magnetic layer and overcoat layer deposited on top of a patterned multilayered antiferromagnetic coupling thin film layer of one embodiment. The net magnetic contrast of the trench region is fully compensated by depositing a full second half magnetic layer 140 of FIG. 1. The deposition thickness of a multilayered antiferromagnetic coupling full second half magnetic layer 420 may be adjusted to achieve the fully compensated net magnetic contrast. The multilayered antiferromagnetic coupling full second half magnetic layer 420 is deposited on the patterned multilayered antiferromagnetic coupling enhancing thin film layer 540. The deposit backfills the clean islands or tracks 220 of FIG. 2. The magnetic materials of the multilayered antiferromagnetic coupling full second half magnetic layer 420 in the islands or tracks 220 of FIG. 2 physically and magnetically connect to the first half of the magnetic layer 340 of one embodiment.

The patterned multilayered antiferromagnetic coupling enhancing thin film layer 540 may be configured using a magnetic material such as cobalt or a cobalt alloy. One or more thin film layer of for example cobalt or a cobalt alloy can be applied to one or both sides of the antiferromagnetic material thin layer for example ruthenium to enhance the antiferromagnetic coupling between the first half and second half of the magnetic layers of one embodiment.

The topography of the islands and tracks 220 and trenches 230 created by the thin film layers of the multilayered antiferromagnetic coupling enhancing thin film layer 540 presents a low height contrast. Physically blurring the low height contrast is accomplished with the deposit of the second half of the magnetic layer 420 materials. The blurred contrast leaves a smooth surface on the top of the second half of the magnetic layer 420. This smooth surface can be used to apply an overcoat layer 150 without additional polishing. Applications of materials for example the carbon over coat 240 of FIG. 2 and the lubricant 250 of FIG. 2 may be used to create the overcoat layer 150. The high magnetic contrast stack 160 of FIG. 1 may have increased flyability and small head to media spacing using the smooth top surface achieved with the overcoat layer 150 of one embodiment.

### Thin Portion of the Second Half of Magnetic Layer:

FIG. 6A, FIG. 6B and FIG. 6C show one embodiment which uses a process of depositing a portion of the second half of the magnetic layer 120 of FIG. 1 on top of the multi-layered antiferromagnetic coupling enhancing thin film layer 500 of FIG. 5A. FIG. 6A shows for illustrative purposes only an example of depositing a multilayered antiferromagnetic coupling enhancing thin film layer and depositing a portion of the second half of the magnetic layer on top of a first half of the magnetic layer of one embodiment. The fabrication process may damage the multilayered antiferromagnetic coupling enhancing thin film layer 500 of FIG. 5A that has been deposited on the first half of the magnetic layer 340.

In one embodiment a portion of the second half of magnetic layer 600 may be deposited on top of the top antiferromagnetic coupling enhancing thin film layer 530. This protection extends to the base antiferromagnetic coupling enhancing thin film layer 520 and middle antiferromagnetic coupling thin film layer 510 after patterning. The portion of the second half of magnetic layer 600 may include back etching or other processes that would reduce the thickness deposited. These fabrication processes may be performed without damaging the multilayered antiferromagnetic coupling enhancing thin film layer 500 of FIG. 5A. Depositing a portion of the second half of the magnetic layer 120 of FIG. 1 prior to patterning also protects the interface regions in the trenches 230 of FIG. 2 during the fabrication process of one embodiment.

FIG. 6B shows for illustrative purposes only an example of patterning a portion of the second half of the magnetic layer and a multilayered antiferromagnetic coupling enhancing thin film layer of one embodiment. Patterning in the portion of the second half of magnetic layer 600 and multilayered antiferromagnetic coupling enhancing thin film layer 500 is configured to use a patterning process such as bit-patterned media or discrete track recording patterning of one embodiment.

The patterning process may not remove any magnetic materials from the first half of the magnetic layer 340. Materials removed in the base antiferromagnetic coupling enhancing thin film layer 510, middle antiferromagnetic coupling enhancing thin film layer 520 and top antiferromagnetic coupling enhancing thin film layer 530 form the islands or tracks 220 of FIG. 2. The patterning in the thin film layers for example a lithographic process results in well preserved islands or tracks 220 with clean well defined edges.

The patterned base antiferromagnetic coupling enhancing thin film layer 525, patterned middle antiferromagnetic coupling thin film layer 515, patterned top antiferromagnetic coupling enhancing thin film layer 535 and patterned portion of the second half of magnetic layer 610 are all thin layers that result in a low height contrast between islands or tracks 220 of FIG. 2 and trenches 230 of FIG. 2. Since the patterned portion of the second half of magnetic layer 610 and the patterned multilayered antiferromagnetic coupling enhancing thin film layer 540 of FIG. 5B forming the trenches 230 of FIG. 2 may not have been exposed to etching and wet chemical process, a strong antiferromagnetic coupling strength is achieved of one embodiment.

FIG. 6C shows for illustrative purposes only an example of depositing a full second half of the magnetic layer and overcoat layer on top of a patterned portion of the second half of the magnetic layer and multilayered antiferromagnetic coupling thin film layer of one embodiment. The patterned portion of the second half of magnetic layer 610 and the patterned multilayered antiferromagnetic coupling enhancing thin film layer 540 of FIG. 5B are covered by depositing a full second half of the magnetic layer 140 of FIG. 1. The full second half of the magnetic layer 420 deposition back fills the islands or tracks 220 of FIG. 2. The back fills of the islands or tracks 220 of FIG. 2 physically and magnetically connects the first and second halves of the magnetic layers. The second half of the magnetic layer 420 materials are deposited in thicknesses that allow creating a fully compensated second half of magnetic layer 420 of one embodiment.

The fully compensated second half of magnetic layer 420 will physically blur the low height contrast between the islands and tracks 220 of FIG. 2 and trenches 230 of FIG. 2. The smoothness of the surface of the second half of the magnetic layer 420 eliminates a polishing process prior to depositing an overcoat layer 150 of FIG. 1. The carbon over coat 240 of FIG. 2 and the lubricant 250 of FIG. 2 may be applied to form the overcoat layer 150.

Flyability and small head to media spacing on the high magnetic contrast stack 160 of FIG. 1 is achieved through the smooth surface of the overcoat layer 150 without additional mechanical polishing processes thusly reducing cost and increasing fabrication efficiencies. The method for fabricating high contrast stacks produces high magnetic contrast ratio conditions resulting from the clean track edges allowing higher track densities to be fabricated. Stacks for example longitudinal or perpendicular magnetic moment oriented recording media such as bit-patterned media and discrete track media fabricated using the method for fabricating high contrast stacks have the highest magnetic contrast and performance qualities of one embodiment.

The foregoing has described the principles, embodiments and modes of operation of the present invention. However, the invention should not be construed as being limited to the particular embodiments discussed. The above described embodiments should be regarded as illustrative rather than restrictive, and it should be appreciated that variations may be made in those embodiments by workers skilled in the art without departing from the scope of the embodiments of the present invention as defined by the following claims.

What is claimed is:

1. A method for fabricating high contrast stacks, comprising:
depositing materials on a substrate to form an antiferromagnetic coupling thin film layer on top of a first half of the magnetic layer of a stack;
depositing a portion of a second half of the magnetic layer on top of the antiferromagnetic coupling thin film layer to couple the first and second half of the magnetic layers to the antiferromagnetic coupling thin film layer; and
patterning a portion of the second half of the magnetic layer and the antiferromagnetic coupling thin film layer.

2. The method of claim 1, wherein the antiferromagnetic coupling thin film layer includes depositing one or more thin film layers that includes at least a thin film layer of ruthenium.

3. The method of claim 2, wherein the depositing further includes depositing a thin film layer of at least one pure cobalt or cobalt alloy on one or more surface of the of the ruthenium thin film layer.

4. The method of claim 1, wherein the method further comprises fabricating stacks with perpendicular magnetic moment orientation.

5. The method of claim 1, wherein the depositing a portion of a second half of the magnetic layer is applied on top of the antiferromagnetic coupling thin film layer.

6. The method of claim 1, wherein patterning includes using patterned media in the antiferromagnetic coupling thin film layer and further comprising using the portion of a second half of the magnetic layer to create high magnetic contrast between islands and trenches to increase extendibility with high island with clean island edges defined.

7. The method of claim 1, further comprising depositing magnetic materials into the islands and on top of trench regions until a net magnetic contrast of the trench region is fully compensated to form a full second half of the magnetic layer.

8. The method of claim 1, further comprising depositing an overcoat layer directly on a surface of the second half of the magnetic layer that includes a carbon over coat layer covered by a lubricant to create a smooth top surface for flyability and small head to stack spacing.

9. The method of claim 1, wherein the patterning creates bit-patterned clean low height contrast between islands and trenches to allow a full second half of the magnetic layer and surface smoothing overcoat to be deposited without surface polishing.

10. An apparatus, comprising:
means for depositing one or more materials in thin film layers to create an antiferromagnetic coupling thin film layer on top of a first half of the magnetic layer of a stack to cancel remnant magnetization;
means for patterning the one or more thin film layers of the antiferromagnetic coupling thin film layer to create clean low height contrast between islands and trenches; and
means for depositing a full second half of the magnetic layer and a surface smoothing overcoat over the single or multi-layered antiferromagnetic coupling thin film layer.

11. The apparatus of 10, wherein the means for patterning creates bit-patterned and discrete track media patterned in the layered antiferromagnetic coupling thin film layer to create high magnetic contrast between islands and trenches to increase extendibility with high track density with clean track edges defined.

12. The apparatus of 10, further comprising means for applying a portion of a second half of the magnetic layer on top of the antiferromagnetic coupling enhancing thin film layer.

13. The apparatus of 10, further comprising means for depositing magnetic materials into the track and on top of the trench regions until the net magnetic contrast of the trench region is fully compensated to form a second half of the magnetic layer.

14. The apparatus of 10, further comprising means for applying an overcoat layer directly on a surface of the second half of the magnetic layer that includes materials such as a carbon over coat layer covered by a lubricant for producing a smooth top surface for flyability and small head to stack spacing.

15. The apparatus of 10, further comprising means for depositing a second half of the magnetic layer and surface smoothing overcoat over the patterned antiferromagnetic coupling thin film layer without surface polishing using mechanical or other processes.

16. A high contrast stack, comprising:
a magnetic layer comprising a first and a second layer;
a surface smoothing overcoat; and
at least one antiferromagnetic coupling thin film layer deposited on top of the first half of the magnetic layer, wherein the at least one antiferromagnetic coupling thin film layer is configured to cancel remnant magnetization and is patterned before depositing the second half of the magnetic layer and the surface smoothing overcoat to create clean low height contrast tracks.

17. The high contrast stack of claim 16, wherein the at least one antiferromagnetic coupling thin film layer is a multilayered antiferromagnetic coupling thin film layer and is formed by depositing two or more thin film layers that include a thin film layer of ruthenium and one or more thin film layer of pure cobalt or cobalt alloy on one or more surface of the ruthenium thin film layer.

18. The high contrast stack of claim 16, wherein a portion of the second half of the magnetic layer is applied on top of the at least one multilayered antiferromagnetic coupling enhancing thin film layer.

19. The high contrast stack of claim 16, wherein the at least one antiferromagnetic coupling enhancing thin film layer is a single and is configured to create high magnetic contrast between islands and trenches to increase extendibility with high island density with clean island edges defined.

20. The high contrast stack of claim 16, further comprising magnetic materials configured to be deposited into the island and on top of trench regions until a net magnetic contrast of the trench region is fully compensated to form a second half of the magnetic layer.
